(19) United States
(12) Patent Application Publication
(10) Pub. No.: US 2010/0195447 A1
(43) Pub. Date: Aug. 5, 2010

(54) Alarm clock and a system and a method to wake a user

(75) Inventor: Nicolas J. George, Ft. Myers, FL (US)

Correspondence Address: PATENTS+TMS, P.C., 2849 W. ARMITAGE AVE., CHICAGO, IL, 60647, US

(73) Assignee: GB11, LLC

(21) Appl. No.: 12/657,754

(22) Filed: Jan. 27, 2010

Related U.S. Application Data
(60) Provisional application No. 61/150,213, filed on Feb. 5, 2009.

(51) Int. Cl. G04C 21/00; H04B 7/00; H04B 3/36; G08B 25/08; G08B 1/08; G08B 5/22; G04B 47/00

(52) U.S. Cl. 368/13; 455/41.3; 340/407.1; 340/692; 340/539.11; 340/7.1; 368/73; 340/7.1

(57) ABSTRACT

An alarm clock, a system and a method wake a user. The alarm clock may have a transmitter which sends a signal to an ear piece which may be worn in and/or on an ear of a user. The earpiece may emit an alert in response to the wireless signal to alert the user to a specified time without disturbing other individuals. The earpiece may have a vibrating module which may emit vibrations into the ear after receiving the signal. The earpiece may have a speaker which may emit an audible alert.

This application claims the benefit of U.S. Provisional Application Ser. No. 61/150,213, filed Feb. 5, 2009.

### BACKGROUND OF THE INVENTION

The present invention generally relates to an alarm clock and a system and a method to wake a user. More specifically, the present invention relates to an alarm clock having a transmitter which sends a wireless signal to an ear piece which may be worn in and/or on an ear of a user. The earpiece may emit an alert in response to the wireless signal to alert the user to a specified time without disturbing other individuals.

The use of alarm clocks is widespread and well known in the prior art. The majority of alarm clocks available today waken users at a predetermined time with a loud audible alert. The audible alert may be a buzzing sound, a ringing sound, music and/or the like. Unfortunately, other individuals within hearing distance of the audible alert will hear the loud audible alert and/or awaken. Thus, the use of the alarm clock by the user may be a problem for other individuals. For example, the user may be a spouse who must awake at an earlier time than the other spouse, and the other spouse may be inconvenienced and/or awakened by the loud audible alert. As a further example, the user may be a parent who must wake without disturbing their children. As yet another example, the user may be a college student who may live in close proximity to one or more roommates and may need to wake without disturbing the roommates.

Silent alarm devices have been developed. Typically, the silent alarm devices are large and require the user to sleep with the silent alarm device in the bed and/or under the pillow. These silent alarm devices disturb others because these silent alarm devices wake the user at a predetermined time by vibrating the bed. In addition, the size and the placement of the silent alarm devices may impair the sleep of the user.

Accordingly, a need exists for a silent alarm clock which may not impair the sleep of the user and may quietly wake the user at a predetermined time without disturbing other individuals located nearby.

### SUMMARY OF THE INVENTION

The present invention generally relates to an alarm clock and a system and a method to wake a user. More specifically, the present invention relates to an alarm clock having a transmitter which sends a wireless signal to an ear piece which may be worn in and/or on an ear of a user. The earpiece may emit an alert in response to the wireless signal to alert the user to a specified time without disturbing other individuals. The earpiece may have a vibrating module which may emit vibrations into the ear after receiving the signal. The base unit and/or the earpiece may have a speaker which may emit an audible alert.

To this end, in an embodiment of the present invention, an alarm clock to wake a user having an ear is provided. The alarm clock has a base unit having a housing and a display wherein the display is connected to the housing; a programmable control unit mechanically connected to the housing wherein the programmable control unit controls the display and further wherein the programmable control unit maintains a current time; a control panel mechanically connected to the housing and electrically connected to the programmable control unit wherein the control panel accepts user input which establishes a first time at which a first alert will be emitted and further wherein the first time is subsequent to the current time when the user input is accepted; a transmitter mechanically connected to the housing and the programmable control unit wherein the programmable control unit directs the transmitter to transmit a wireless signal when the current time matches the first time; an earpiece having a receiver which receives the wireless signal from the transmitter wherein the earpiece is adapted to be worn in the ear of the user; and an alert means connected to the earpiece wherein the alert means emits the first alert.

In an embodiment, the alarm clock has radio frequency waves sent by the transmitter to the receiver wherein the radio frequency waves convey the wireless signal using a wavelength between 100 km and 1 mm infrared light waves, such as, for example, waves having a wavelength between 0.7 micrometers and 300 micrometers.

In an embodiment, the alarm clock has infrared light waves sent by the transmitter to the receiver wherein the infrared light waves convey the wireless signal using a wavelength between 0.7 micrometers and 300 micrometers.

In an embodiment, the transmitter and the receiver use Bluetooth wireless protocol to transmit and receive the wireless signal.

In an embodiment, the alarm clock has a dial mechanically connected to the control pad wherein the user input is based on rotation of the dial relative to the base unit.

In an embodiment, the alarm clock has a button on the earpiece wherein the earpiece ceases emitting the first alert in response to deactivating the button.

In an embodiment, the alarm clock has a vibrating module on the earpiece wherein the vibrating module is the alert means and further wherein the first alert is vibrations emitted by the vibrating module.

In an embodiment, the alarm clock has a speaker on the earpiece wherein the speaker is the alert means and further wherein the first alert is an audible alert emitted from the speaker.

In an embodiment, the alarm clock has a docking station mechanically connected and electrically connected to the base unit wherein the docking station charges the earpiece if the earpiece is connected to the docking station.

In an embodiment, the alarm clock has a speaker connected to the base unit wherein the speaker emits a second alert which is an audible alert when a second time established by user input on the control panel matches the current time and further wherein the second time is a different time than the first time.

In another embodiment of the present invention, a method for waking a user with an alarm clock having an earpiece and a base unit is provided. The method has the steps of monitoring a current time wherein the base unit monitors the current time; accepting user input on the base unit wherein the user input identifies a first alarm time and an alarm type and further wherein the alarm type is one of an audio alert and a vibrational alert; associating a first alert with the first alarm time and the alarm type wherein the base unit associates the first alert with the first alarm time and the alarm type; emitting the first alert as the audio alert from the earpiece when the current time matches the first alarm time if the alarm type is the audio alert; and emitting the first alert as the vibrational alert when the current time matches the alarm time if the alarm type is the vibrational alert.

In an embodiment, the method has the step of emitting an additional alert from a speaker connected to the base unit when the current time matches a second alarm time which is a different time than the first alarm time.

In an embodiment, the method has the step of transmitting a wireless signal from the base unit to the earpiece when the current time matches the alarm time wherein the earpiece emits the first alert in response to the wireless signal.

In an embodiment, the method has the step of executing an application on a mobile telephone of the user wherein the mobile telephone is the base unit and further wherein the mobile telephone directs the earpiece to emit the first alert when the current time matches the alarm time.

In an embodiment, the method has the step of transmitting information to the base unit from a mobile telephone which is a different device than the base unit wherein the alarm time is based on the information.

In an embodiment, the method has the step of emitting light from the earpiece if a paging button connected to the base unit is pressed.

In an embodiment, the method has the step of emitting light from the base unit if the earpiece is connected to the base unit for charging.

In another embodiment of the present invention, a system to wake a user having an ear is provided. The system has an earpiece having a receiver wherein the earpiece is adapted to be worn in the ear of the user; a mobile telephone having Bluetooth wireless transmission capabilities wherein the mobile telephone stores a current time and further wherein the mobile telephone accepts user input which indicates a first time which is subsequent to the current time when the user input is accepted; and an application executed by the mobile telephone wherein the application directs the mobile telephone to transmit a wireless signal to the earpiece using the Bluetooth wireless transmission capabilities when the current time matches the first time and further wherein the earpiece emits an alert in response to receipt of the wireless signal.

In an embodiment, the application directs the mobile telephone to transmit an additional wireless signal to the earpiece using the Bluetooth wireless transmission capabilities when the current time matches a second time which is a different time than the first time and further wherein the earpiece emits an additional alert in response to receipt of the additional wireless signal.

In an embodiment, the application enables an additional user located remotely relative to the mobile telephone to view the predetermined time using the internet.

It is, therefore, an advantage of the present invention to provide an alarm clock and a system and a method to wake a user.

Another advantage of the present invention is to provide an alarm clock and a system and a method to wake a user which may wake the user without disturbing others who are located nearby.

A further advantage of the present invention is to provide an alarm clock and a system and a method to wake a user which may use an earpiece which may be comfortable to wear in and/or on an ear of the user.

Yet another advantage of the present invention is to provide an alarm clock and a system and a method to wake a user which may not impair sleep of the user.

Another advantage of the present invention is to provide an alarm clock and a system and a method to wake a user which may provide a first alert using an earpiece and a second alert using a base unit.

A further advantage of the present invention is to provide an alarm clock and a system and a method to wake a user which may enable individuals located remotely relative to the alarm clock to view alarm times specified by the user.

Yet another advantage of the present invention is to provide an alarm clock and a system and a method to wake a user which may use a mobile telephone to direct an earpiece to emit an alert.

Another advantage of the present invention is to provide an alarm clock and a system and a method to wake a user which may enable the user to select a type of alert emitted by the alarm clock.

A further advantage of the present invention is to provide an alarm clock and a system and a method to wake a user which may use an earpiece and a base unit which may charge the earpiece.

Yet another advantage of the present invention is to provide an alarm clock and a system and a method to wake a user which may use an earpiece which emits an alert and has a button for stopping emission of the alert.

Moreover, an advantage of the present invention is to provide an alarm clock and a system and a method to wake a user which may use Bluetooth wireless transmission technology.

Additional features and advantages of the present invention are described in, and will be apparent from, the detailed description of the presently preferred embodiments and from the drawings.

### BRIEF DESCRIPTION OF THE DRAWINGS

FIG. 1 illustrates a flowchart of a method for using an alarm clock in an embodiment of the present invention.

FIG. 2 illustrates a top perspective view of a base unit for an alarm clock in an embodiment of the present invention.

FIGS. 3 and 4 illustrate a side view of earpieces of an alarm clock in an embodiment of the present invention.

FIG. 5 illustrates a front perspective view of an alarm clock in an embodiment of the present invention.

FIG. 6 illustrates a rear perspective view of an alarm clock in an embodiment of the present invention.

FIG. 7 illustrates a top plan view of an alarm clock in an embodiment of the present invention.

FIGS. 8A and 8B illustrate side perspective views of an earpiece of an alarm clock in an embodiment of the present invention.

FIG. 9 illustrates a flowchart of a method for using a silent alarm clock in an embodiment of the present invention.

FIG. 10 illustrates a side perspective view of an alarm clock in an embodiment of the present invention.

### DETAILED DESCRIPTION OF THE PRESENTLY PREFERRED EMBODIMENTS

The present invention generally relates to an alarm clock and a system and a method to wake a user. More specifically, the present invention relates to an alarm clock having a transmitter which sends a wireless signal to an ear piece which may be worn in and/or on an ear of a user. The earpiece may emit an alert in response to the wireless signal to alert the user to a specified time without disturbing other individuals. The earpiece may have a vibrating module which may emit vibrations into the ear after receiving the signal. The base unit and/or the earpiece may have a speaker which may emit an audible alert.

The transmitter may send the wireless signal to a receiver connected to the earpiece using wireless transmission, such as, for example, radio signals; radio frequency waves, such as, for example, waves having a wavelength between 100 km and 1 mm and/or a frequency between 3 KHz and 300 GHz; infrared light waves, such as, for example, waves having a wavelength between 0.7 micrometers and 300 micrometers and/or a frequency between 1 THz and 430 THz; transmission using the Bluetooth (certification mark of Bluetooth SIG, Inc.) wireless protocol; and/or the like. The base unit may have a housing which may have a display which may display a current time and/or settings. The housing may have the speaker for emitting the audible alert. The housing may have a programmable control unit which may be connected to the housing and/or may control the display and/or the transmitter. The programmable control unit may direct the transmitter to send the wireless signal to the receiver at the specified time.

A control panel which may be connected to the housing may enable the user to program the programmable control unit. For example, the programmable control unit may be programmed to wake a first user at a first predetermined time using the earpiece, and/or the programmable control unit may be programmed to wake a second user at a second predetermined time using a second audible alert emitted from the base unit or an additional earpiece.

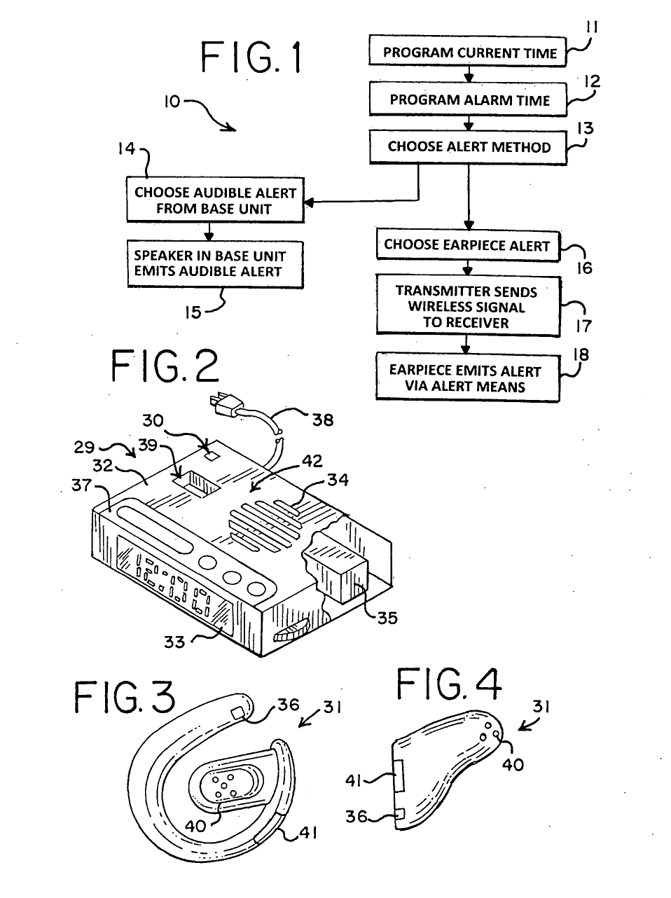

Referring now to the drawings wherein like numerals refer to like parts, FIG. 1 generally illustrates a flowchart of a method 10 for an alarm clock to wake a user in an embodiment of the present invention. As shown at step 11, the user may program a current time into a programmable control unit located in, located on and/or connected to a base unit. For example, the user may program the current time into the programmable control unit using a control panel located on and/or connected to the base unit. As shown at step 12, the user may program one or more alarm times into the programmable control unit. For example, the user may use the control panel to program the one or more alarm times. Each of the one or more alarm times may be a time at which the user and/or an additional user desire to be wakened and/or alerted. As shown at step 13, the user may select an alarm type for the one or more alarm times.

For example, for a first alarm time, the user may select an audible alert from a speaker which may be connected to the base unit as shown at step 14. As shown at step 15, the programmable control unit may activate the speaker and/or the speaker may emit the audible alert at the first alarm time.

As a further example, for the first alarm time, the user may select an alert from an earpiece placed in and/or on an ear of the user as shown at step 16. As shown at step 17, at the first alarm time, a transmitter connected to the base unit may send a wireless signal to the earpiece. For example, the transmitter may send the wireless signal to a receiver connected to the earpiece. The transmitter may send the wireless signal to the receiver using wireless transmission, such as, for example, radio signals, radio frequency waves, infrared light waves, transmission using the Bluetooth wireless protocol, and/or the like. The present invention is not limited to a specific embodiment of the wireless transmission. As shown at step 18, the earpiece may emit the alert. A speaker and/or a vibrating module may be located in and/or connected to the earpiece. The alert emitted from the earpiece may be an audible alert emitted by the speaker and/or may be vibrations emitted by the vibrating module.

FIGS. 2-4 generally illustrate a base unit 29 of the alarm clock 20. The base unit 29 may have a transmitter 30 which may send a wireless signal to an earpiece 31. In an embodiment, the transmitter 30 may be located inside of the base unit 29. The base unit 29 may have a housing 32. In an embodiment, the transmitter 30 may be connected to the housing 32 of the base unit 29. A display 33 may be connected to the housing 32, and/or the display 33 may display the current time, the alarm times and/or user settings. A speaker 34 may be connected to the housing 32, and/or the speaker 34 may emit the audible alert. A programmable control unit 35 may be located in, may be located on and/or may be connected to the housing 32.

User input on the alarm clock 20 may program the programmable control unit 35 to direct the speaker 34 to emit the audible alert at the first alarm time and/or to direct the transmitter 30 to send the wireless signal to the earpiece 31 at the first alarm time. For example, the transmitter 30 may send the wireless signal to a receiver 36 which may be connected to the earpiece 31. A control panel 37 which may have one or more buttons and/or one or more switches may be located on and/or may be connected to the housing 32. For example, in an embodiment, the housing 32 may have a top side 42, and/or the control panel 37 may be located on the top side 42 of the housing 32.

The base unit 29 may have a power cord 38 and/or batteries (not shown) for obtaining power. The power cord 38 may be connected to the housing 32. The base unit 29 may have a docking station 39 which may connect to the earpiece 31. For example, in an embodiment, the docking station 39 may be located on the top side 42 of the housing 32. The earpiece 31 may be charged by the base unit 29 if the earpiece 31 is connected to the docking station 39. The present invention is not limited to a specific location of the transmitter 30, the display 33, the speaker 34, the programmable control unit 35, the control panel 37, the power cord 38 or the docking station 39 on the housing 32.

FIGS. 3 and 4 generally illustrate embodiments of the earpiece 31 which may be worn on and/or in an ear of the user. The earpiece 31 may have the receiver 36 for receiving the wireless signal from the transmitter 30 of the base unit 29. The earpiece 31 may have an alert means 40. The alert means 40 may be, for example, a speaker which may emit an audible alert in response to the wireless signal, and/or may be a vibrating module which may emit vibrations in response to the wireless signal. For example, the alert means 40 may be activated by the receiver 36 after the receiver 36 receives the wireless signal from the transmitter 30. The audible alert and/or the vibrations may indicate the alarm time to the user and/or may wake the user at the alarm time. The earpiece 31 may have a port 41 which may connect the earpiece 31 to the docking station 39 of the base unit 29. Connection of the earpiece 31 to the docking station 39 may charge a battery (not shown) which may be located in and/or may be connected to the earpiece 31.

As discussed previously, the user and/or the additional user may establish the alarm times for the programmable control unit 35 and/or the alarm clock 20. Each of the alarm times may be a time at which the user and/or the additional user desires to be awakened and/or alerted. For example, the user may establish the first alarm time for the programmable control unit and/or may direct the programmable control unit 35 to transmit the wireless signal to the earpiece 31 at the first alarm time. The second user may establish a second alarm time and/or may direct the programmable control unit 35 to emit the audible alert from the base unit 29 at the second alarm time. For example, the base unit 29 may emit the audible alert from the speaker 34 which may be connected to the housing 32. Accordingly, the alarm clock 20 may enable the user and the additional user to be awakened at different predetermined times using different types of alerts. The present invention is not limited to a specific number of users or alarm times.

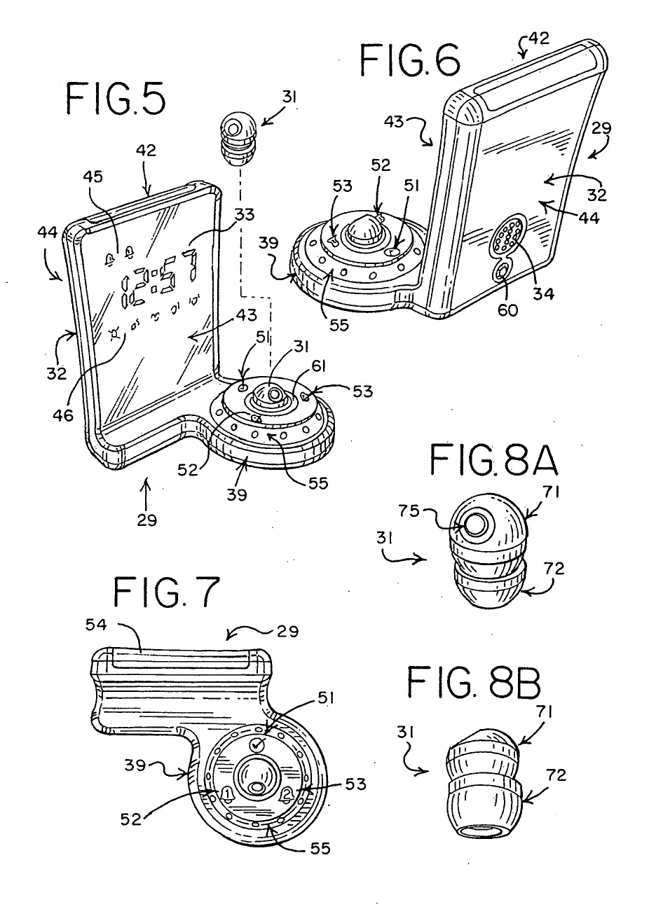

FIGS. 5-7 generally illustrate an embodiment of the base unit 29 of the alarm clock 20. As previously discussed, the base unit 29 may transmit the wireless signal to the earpiece 31. The base unit 29 may have the housing 32 which may have the top side 42, a front side 43 and/or a rear side 44 which may be located in a position opposite to the front side 43. The programmable control unit 35 may be located inside of the housing 32. The display 33 may be located on the front side 43 of the housing 32. The display 33 may display a time 44, status indicators 45 and/or function indicators 46. As generally illustrated in FIG. 6, the speaker 34 which may emit the audible alert from the base unit 29 may be located on the rear side 44 of the housing 32. The housing 32 of the base unit 29 may have an inlet 60 to which the power cord 38 may connect for the base unit 29 to obtain power. In an embodiment, the inlet 60 may be located below the speaker 34. The present invention is not limited to a specific location of the display 33, the speaker 34, the programmable control unit 35 or the inlet 60 on the housing 32.

Referring again to FIGS. 5-7, the base unit 29 may have the docking station 39 which may connect to the earpiece 31. For example, the docking station 39 may extend from the front side 43 of the housing 32 and/or may be located below the display 33. The earpiece 31 may be charged by the base unit 29 if the earpiece 31 is connected to the docking station 39. The docking station 39 may emit light if the earpiece 31 is connected to the docking station 39 and/or is being charged by the base unit 29. For example, the docking station 39 may have a ring 61 which may emit the light if the earpiece 31 is being charged by the base unit 29.

User input on the alarm clock 20 may program the programmable control unit 35 to establish the current time. Further, user input on the alarm clock 20 may program the programmable control unit 35 to direct the speaker 34 to emit the audible alert at a predetermined alarm time. Still further, user input on the alarm clock 20 may program the programmable control unit 35 to direct the transmitter 30 to send the wireless signal to the earpiece 31 at a predetermined alarm time. For example, the docking station 39 may have the control panel 37 for accepting the user input. The control panel 37 may have a first button 51, a second button 52, a third button 53 and/or a setting dial 55. In an embodiment, the setting dial 55 may surround the first button 51, the second button 52 and/or the third button 53 on the docking station 39. The present invention is not limited to a specific embodiment of the control panel 37.

If the user pushes the first button 51 into a depressed position for a predetermined time period, such as, for example, two seconds, the programmable control unit 35 may enter a “time set” mode. In time set mode, the user may rotate the setting dial 55 to establish and/or change the current time. For example, in the “time set” mode, the user may rotate the setting dial 55 in a first direction to make the current time later, and/or the user may rotate the setting dial 55 in a second direction opposite to the first direction to make the current time earlier. In time set mode, the user may push the first button 51 to change a time display setting from a twelve-hour setting to a twenty-four hour setting and/or from the twenty-four hour setting to the twelve-hour setting. The user may push and hold the first button 51 for the predetermined time period to exit the “time set” mode. The alarm clock 20 may exit the “time set” mode by saving the time display setting and/or the current time.

If the user pushes the second button 52, the display 33 may display the first alarm time and/or a first symbol. If the user pushes the third button 53, the display 33 may display the second alarm time and/or a second symbol. The first symbol and/or the second symbol may be displayed in the status indicators 45. The first symbol may indicate that the time 44 displayed by the display 33 is the first alarm time, and the second symbol may indicate that the time 44 displayed by the display 33 is the second alarm time.

If the user pushes the second button 52 and/or the third button 53, the function indicators 46 may indicate an alert type associated with the first alarm time and/or the second alarm time, respectively. For example, the function indicators 46 may indicate whether the first alarm time and/or the second alarm time will be indicated to the user by the speaker 34 of the base unit 29, the speaker of the earpiece 31 and/or the alert means 40 of the earpiece 31. Further, the function indicators 46 may indicate whether the alert means 40 of the earpiece 31 will indicate the first alarm time and/or the second alarm time, respectively, using an audible alert emitted from a speaker of the earpiece 31 and/or vibrations emitted by a vibrating module of the earpiece 31.

In an embodiment, the function indicators 46 may be a first icon, a second icon, a third icon, a fourth icon and/or a fifth icon. The first icon, the second icon, the third icon, the fourth icon and/or the fifth icon may be different icons. For example, the first icon, the second icon, the third icon, the fourth icon and/or the fifth icon may be different graphic representations, different colors, different text and/or the like. The present invention is not limited to a specific embodiment of the function indicators 46.

The first icon may be an “alarm off” icon. If the user pushes the second button 52, display of the first symbol and the first icon may indicate that the alarm clock 20 will not emit an alert for the first alarm time. If the user pushes the third button 53, display of the second symbol and the first icon may indicate that the alarm clock 20 will not emit an alert for the second alarm time.

If the user pushes the second button 52, display of the first symbol and the second icon may indicate that the alarm clock 20 will emit the alert for the first alarm time using the speaker 34 of the base unit 29. If the user pushes the third button 53, display of the second symbol and the second icon may indicate that the alarm clock 20 will emit the alert for the second alarm time using the speaker 34 of the base unit 29.

If the user pushes the second button 52, display of the first symbol and the third icon may indicate that the alarm clock 20 will emit the alert for the first alarm time using an audible alert emitted from the speaker of the earpiece 31. If the user pushes the third button 53, display of the second symbol and the third icon may indicate that the alarm clock 20 will emit the alert for the second alarm time using an audible alert emitted from the speaker of the earpiece 31.

If the user pushes the second button 52, display of the first symbol and the fourth icon may indicate that the alarm clock 20 will emit the alert for the first alarm time using vibrations emitted from the vibration module of the earpiece 31. If the user pushes the third button 53, display of the second symbol and the fourth icon may indicate that the alarm clock 20 will emit the alert for the second alarm time using vibrations emitted from the vibration module of the earpiece 31.

If the user pushes the second button 52, display of the first symbol and the fifth icon may indicate that the alarm clock 20 will emit the alert for the first alarm time using both an audible alert and vibrations emitted from the earpiece 31. If the user pushes the third button 53, display of the second symbol and the fourth icon may indicate that the alarm clock 20 will emit the alert for the second alarm time using both an audible alert and vibrations emitted from the earpiece 31.

If the user pushes the second button 52 into a depressed position for a predetermined time period, such as, for example, two seconds, the programmable control unit 35 may enter a “first alarm set” mode. In the “first alarm set” mode, the user may push the second button 52 to toggle between alert types for the first alarm time. For example, in the “first alarm set” mode, the user may push the second button 52 to establish whether the alarm clock 20 will respond to the first alarm time by not emitting an alert, by emitting an audible alert using the speaker 34 of the base unit 29, by emitting an audible alert from the earpiece 31, by emitting vibrations from the earpiece 31, or by emitting both an audible alert and vibrations from the earpiece 31. The first icon, the second icon, the third icon, the fourth icon and/or the fifth icon may indicate a current setting for the alert types for the first alarm time as the user uses the second button 52 to toggle between the alert types for the first alarm time.

In the “first alarm set” mode, the user may use the setting dial 55 and/or the time 44 displayed by the alarm clock 20 to establish and/or change the first alarm time. For example, in the “first alarm set” mode, the user may turn the setting dial 55 in a first direction to make the first alarm time later, and/or the user may turn the setting dial 55 in a second direction opposite to the first direction to make the first alarm time earlier. If the user pushes the second button 52 into the depressed position for the predetermined time period, the alarm clock 20 may exit the “first alarm set” mode. The programmable control unit may exit the “first alarm set” mode by saving the first alarm time and/or the function associated with the first alarm time.

If the user pushes the third button 53 into a depressed position for a predetermined time period, such as, for example, two seconds, the programmable control unit 35 may enter a “second alarm set” mode. In the “second alarm set” mode, the user may push the third button 53 to toggle between alarm functions for the second alarm time. For example, in the “second alarm set” mode, the user may push the third button 53 to establish whether the alarm clock 20 will respond to the second alarm time by not emitting an alert, by emitting an audible alert using the speaker 34 of the base unit 29, by emitting an audible alert from the earpiece 31, by emitting vibrations from the earpiece 31, or by emitting both an audible alert and vibrations from the earpiece 31. The first icon, the second icon, the third icon, the fourth icon and/or the fifth icon may indicate a current setting for the alert types for the second alarm time as the user uses the third button 53 to toggle between the alert types for the second alarm time.

In the “second alarm set” mode, the user may use the setting dial 55 and/or the time 44 displayed by the alarm clock 20 to establish and/or change the second alarm time. For example, in the “second alarm set” mode, the user may turn the setting dial 55 in a first direction to make the first alarm time later, and/or the user may turn the setting dial 55 in a second direction opposite to the first direction to make the first alarm time earlier. If the user pushes the second button 52 into the depressed position for the predetermined time period, the alarm clock 20 may exit the “first alarm set” mode. The programmable control unit 35 may exit the “first alarm set” mode by saving the second alarm time and/or the function associated with the second alarm time.

The housing 32 may have a fourth button 54. In an embodiment, the fourth button 54 may be located on the top side 42 of the housing 32. If the alarm clock 20 is emitting an alert, the user may push the fourth button 54 to invoke a “snooze” function for the alert as known to one having ordinary skill in the art. For example, pushing the fourth button 54 may direct the speaker 34 of the base unit 29 and/or the alert means 40 of the earpiece 31 to cease emitting the alert. As another example, pushing the fourth button 54 may direct the speaker 34 of the base unit 29 and/or the alert means 40 of the earpiece 31 to emit the alert again after a predetermined time period, such as, for example, five minutes, seven minutes, ten minutes and/or the like. The present invention is not limited to a specific embodiment of the “snooze” function which may be invoked by pushing the fourth button 54.

In an embodiment, the user may push and hold the fourth button 54 for a predetermined time period, such as, for example, five seconds, to “page” the earpiece 31. If the earpiece 31 is “paged,” the earpiece 31 may vibrate, may emit light, may emit audible sounds and/or the like to enable the user to locate the earpiece 31.

FIGS. 8A and 8B generally illustrate an embodiment of the earpiece 31. The earpiece 31 may have a first portion 71 and/or a second portion 72 which may extend from the first portion 71. The second portion 72 of the earpiece 31 may taper such that a width of the second portion 72 of the earpiece 31 may decrease as a distance from the first portion 71 of the earpiece 31 increases. The second portion 72 of the earpiece 31 may be inserted in an ear of the user. The first portion 71 of the earpiece 31 may have an earpiece button 75. The user may push the earpiece button 75 to invoke the “snooze” function for the alert as previously described. The user may push and hold the earpiece button 75 for a predetermined time period, such as, for example, two seconds, three seconds and/or the like, to direct the earpiece 31 to cease emitting the alert.

The earpiece 31 may emit light, such as, for example, from an LED (not shown) connected to the earpiece 31. In an embodiment, the earpiece 31 may emit light from the earpiece button 75 and/or an LED located inside of the earpiece button 75. The earpiece 31 may emit a first color of light and/or intermittently emit light such that the earpiece is “flashing” to indicate that the earpiece 31 has energy below a threshold value. The earpiece 31 may emit a second color of light to indicate that the earpiece 31 has energy above the threshold value. Alternatively, the earpiece 31 may emit the second color of light to indicate that an alert is scheduled for the first alarm time and/or the second alarm time.

The earpiece 31 may have a volume control module (not shown). The volume control module may enable the user to adjust a volume of the audible alert. For example, the user may use the volume control module to increase and/or decrease the volume of the audible alert produced by the speaker of the earpiece 31.

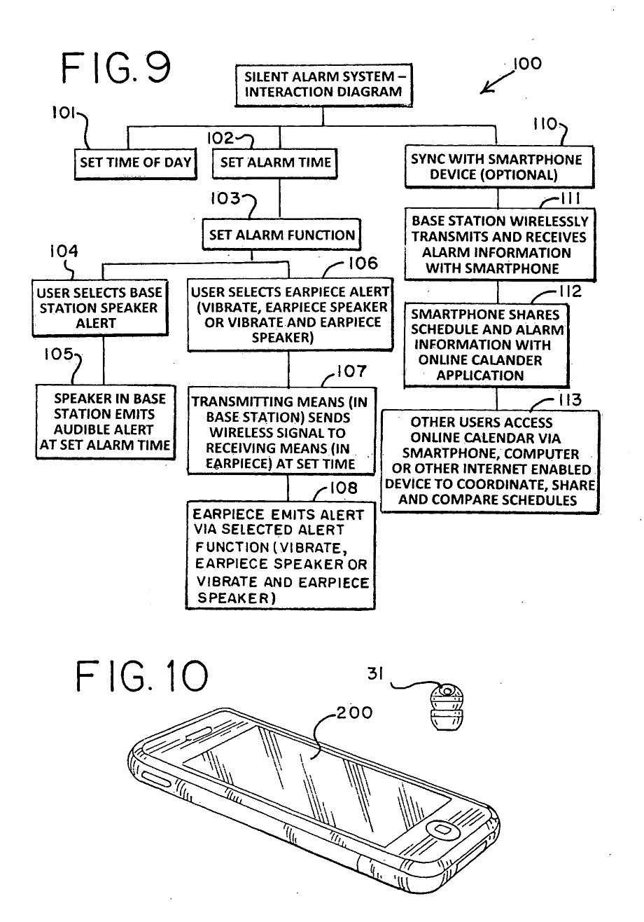

FIG. 9 generally illustrates a flowchart of a method 100 for an alarm clock to wake a user in an embodiment of the present invention. As shown at step 101, the user may program a current time into the programmable control unit 35 of the base unit 29. For example, the user may program the current time into the programmable control unit 35 using the control panel 37 located on and/or connected to the base unit 29. As a further example, the user may program the current time into the programmable control unit 35 using the first button 51 and/or the setting dial 55.

As shown at step 102, the user may program one or more alarm times into the programmable control unit. For example, the user may use the control panel 37 to program the one or more alarm times. As another example, the user may program the first alarm time into the programmable control unit 35 using the second button 52 and/or the setting dial 55. As yet another example, the user may program the second alarm time into the programmable control unit 35 using the third button 53 and/or the setting dial 55. Each of the one or more alarm times may be a time at which the user and/or an additional user desires to be awakened and/or alerted.

As shown at step 103, the user may select an alert method for receiving an alert for the one or more alarm times. For example, for the first alarm time, the user may select an audible alert from the speaker 34 of the base unit 29 as shown at step 104. As shown at step 105, the programmable control unit 35 may activate the speaker 34 of the base unit 29 at the first alarm time, and/or the speaker 34 of the base unit 29 may emit the audible alert at the first alarm time. As another example, for the first alarm time, the user may select emission of the alert from the earpiece 31 as shown at step 106. As shown at step 107, at the first alarm time, the transmitter 30 of the base unit 29 may send the wireless signal to the earpiece 31. For example, the transmitter 30 may send the wireless signal to the receiver 36 of the earpiece 31. As shown at step 108, the earpiece 31 may emit the alert using the speaker and/or the vibrating module of the earpiece 31 according to the alert type selected by the user.

FIG. 10 generally illustrates an embodiment of the alarm clock 20 which may use a mobile telephone 200. In an embodiment, the mobile telephone 200 may function as the base unit 29 and/or may communicate directly with the earpiece 31, such as, for example, by using the Bluetooth wireless protocol. The user may establish the alarm times, such as, for example, the first alarm timer and/or the second alarm time, using the mobile telephone 200.

In another embodiment, the mobile telephone 200 and the base unit 29 may be different devices and/or may communicate with each other, such as, for example, by physically connecting to each other and/or by using the Bluetooth wireless protocol. The mobile telephone 200 may store information associated with the user and/or transmit the information to the base unit 29 and/or the earpiece 31. For example, the mobile telephone 200 may store a schedule of the user and/or transmit the schedule to the base unit 29 and/or the earpiece 31. The alarm clock 20 may establish and/or may change the first alarm time and/or the second alarm time based on the information and/or the schedule. Alternatively, the user may establish the alarm times using the mobile telephone 200, and/or the mobile telephone 200 may transmit the alarm times to the base unit 29.

In an embodiment, the user may hold down the earpiece button 75 for a predetermined time period, such as, for example, ten seconds, to synchronize the earpiece 31 to the base unit 29 and/or the mobile telephone 200. Synchronization of the earpiece 31 to the base unit 29 and/or the mobile telephone 200 may direct the base unit 29 and/or the mobile telephone 200 to communicate with the earpiece 31. For example, synchronization of the earpiece 31 to the base unit 29 and/or the mobile telephone 200 may direct the base unit 29 and/or the mobile telephone 200 to transmit the wireless signal to the earpiece 31 at the alarm times, such as, for example, the first alarm time and/or the second alarm time.

In an embodiment, the mobile telephone 200 may obtain, may store and/or may execute an application. For example, the application may be a pre-installed application that may be installed on the mobile telephone 200 before purchase of the mobile telephone 200 by the user of the mobile telephone 200. Alternatively, the application may be downloaded, may be obtained and/or may be installed by the user of the mobile telephone 200. The application may process the schedule of the user and/or user input from the user to establish and/or change the alarm times, such as, for example, the first alarm time and/or the second alarm time. In an embodiment, the application may enable the mobile telephone 200 to implement user input which may control emission of the alert. For example, the mobile telephone 200 and/or the base unit 29 may direct the earpiece 31 to cease emitting the alert in response to user input on the mobile telephone 200. As another example, the mobile telephone 200 and/or the base unit 29 may invoke the “snooze” function for the earpiece 31 as previously described in response to user input on the mobile telephone 200.

Referring again to FIG. 9, as shown in step 109, the alarm clock 20 may synchronize with the base unit 29 and/or the mobile telephone 200. Synchronization of the earpiece 31 to the base unit 29 and/or the mobile telephone 200 may direct the base unit 29 and/or the mobile telephone 200 to communicate with the earpiece 31. For example, synchronization of the earpiece 31 to the base unit 29 and/or the mobile telephone 200 may direct the base unit 29 and/or the mobile telephone 200 to transmit the wireless signal to the earpiece 31 at the alarm times, such as, for example, the first alarm time and/or the second alarm time.

As shown at step 111, in an embodiment where the mobile telephone 200 and the base unit 29 are different devices, the base unit 29 may request information from the mobile telephone 200, and/or the mobile telephone 200 may transmit the information to the base unit 29. For example, the mobile telephone 200 may transmit the schedule of the user and/or the alarm times to the base unit 29.

As shown in step 112, in an embodiment, the mobile telephone 200, the base unit 29 and/or the application may share the information, such as, for example, the schedule of the user and/or the alarm times, with an online calendar application. As shown in step 113, the online calendar application may enable individuals located remotely relative to the user to view the information, the schedule and/or the alarm times. For example, the individuals located remotely relative to the user may use the online calendar application, the internet, a mobile telephone, another internet-enabled device, and/or the like to view the information. For example, one of the individuals located remotely relative to the user may view the alarm times of the user using the internet if the one of the individuals located remotely relative to the user is authorized by the user.

Accordingly, the alarm clock 20 may have the base unit 29 and/or the mobile telephone 200 which may transmit the wireless signal to the ear piece 31 which may be worn in and/or on the ear of the user. The earpiece 31 may emit an alert in response to the wireless signal to alert the user to a specified time without disturbing other individuals.

It should be understood that various changes and modifications to the presently preferred embodiments described herein will be apparent to those skilled in the art. Such changes and modifications may be made without departing from the spirit and scope of the present invention and without diminishing its attendant advantages.

I claim:

1. An alarm clock to wake a user having an ear, the alarm clock comprising:
a base unit having a housing and a display wherein the display is connected to the housing;
a programmable control unit mechanically connected to the housing wherein the programmable control unit controls the display and further wherein the programmable control unit maintains a current time;
a control panel mechanically connected to the housing and electrically connected to the programmable control unit wherein the control panel accepts user input which establishes a first time at which a first alert will be emitted and further wherein the first time is subsequent to the current time when the user input is accepted;
a transmitter mechanically connected to the housing and the programmable control unit wherein the programmable control unit directs the transmitter to transmit a wireless signal when the current time matches the first time;
an earpiece having a receiver which receives the wireless signal from the transmitter wherein the earpiece is adapted to be worn in the ear of the user; and
an alert means connected to the earpiece wherein the alert means emits the first alert.

2. The alarm clock of claim 1 further comprising:
radio frequency waves sent by the transmitter to the receiver wherein the radio frequency waves convey the wireless signal using a wavelength between 100 km and 1 mm infrared light waves, such as, for example, waves having a wavelength between 0.7 micrometers and 300 micrometers.

3. The alarm clock of claim 1 further comprising:
infrared light waves sent by the transmitter to the receiver wherein the infrared light waves convey the wireless signal using a wavelength between 0.7 micrometers and 300 micrometers.

4. The alarm clock of claim 1 wherein the transmitter and the receiver use Bluetooth wireless protocol to transmit and receive the wireless signal.

5. The alarm clock of claim 1 further comprising:
a dial mechanically connected to the control pad wherein the user input is based on rotation of the dial relative to the base unit.

6. The alarm clock of claim 1 further comprising:
a button on the earpiece wherein the earpiece ceases emitting the first alert in response to deactivating the button.

7. The alarm clock further comprising:
a vibrating module on the earpiece wherein the vibrating module is the alert means and further wherein the first alert is vibrations emitted by the vibrating module.

8. The alarm clock of claim 1 further comprising:
a speaker on the earpiece wherein the speaker is the alert means and further wherein the first alert is an audible alert emitted from the speaker.

9. The alarm clock of claim 1 further comprising:
a docking station mechanically connected and electrically connected to the base unit wherein the docking station charges the earpiece if the earpiece is connected to the docking station.

10. The alarm clock of claim 1 further comprising:
a speaker connected to the base unit wherein the speaker emits a second alert which is an audible alert when a second time established by user input on the control panel matches the current time and further wherein the second time is a different time than the first time.

11. A method for waking a user with an alarm clock having an earpiece and a base unit, the method comprising the steps of:
monitoring a current time wherein the base unit monitors the current time;
accepting user input on the base unit wherein the user input identifies a first alarm time and an alarm type and further wherein the alarm type is one of an audio alert and a vibrational alert;
associating a first alert with the first alarm time and the alarm type wherein the base unit associates the first alert with the first alarm time and the alarm type;
emitting the first alert as the audio alert from the earpiece when the current time matches the first alarm time if the alarm type is the audio alert; and
emitting the first alert as the vibrational alert when the current time matches the alarm time if the alarm type is the vibrational alert.

12. The method of claim 11 further comprising the step of:
emitting an additional alert from a speaker connected to the base unit when the current time matches a second alarm time which is a different time than the first alarm time.

13. The method of claim 11 further comprising the step of:
transmitting a wireless signal from the base unit to the earpiece when the current time matches the alarm time wherein the earpiece emits the first alert in response to the wireless signal.

14. The method of claim 11 further comprising the step of:
executing an application on a mobile telephone of the user wherein the mobile telephone is the base unit and further wherein the mobile telephone directs the earpiece to emit the first alert when the current time matches the alarm time.

15. The method of claim 11 further comprising the step of:
transmitting information to the base unit from a mobile telephone which is a different device than the base unit wherein the alarm time is based on the information.

16. The method of claim 11 further comprising the step of:
emitting light from the earpiece if a paging button connected to the base unit is pressed.

17. The method of claim 11 further comprising the step of:
emitting light from the base unit if the earpiece is connected to the base unit for charging.

18. A system to wake a user having an ear, the system comprising:
an earpiece having a receiver wherein the earpiece is adapted to be worn in the ear of the user;
a mobile telephone having Bluetooth wireless transmission capabilities wherein the mobile telephone stores a current time and further wherein the mobile telephone accepts user input which indicates a first time which is subsequent to the current time when the user input is accepted; and
an application executed by the mobile telephone wherein the application directs the mobile telephone to transmit a wireless signal to the earpiece using the Bluetooth wireless transmission capabilities when the current time matches the first time and further wherein the earpiece emits an alert in response to receipt of the wireless signal.

19. The system of claim 18 wherein the application directs the mobile telephone to transmit an additional wireless signal to the earpiece using the Bluetooth wireless transmission capabilities when the current time matches a second time which is a different time than the first time and further wherein the earpiece emits an additional alert in response to receipt of the additional wireless signal.

20. The system of claim 18 wherein the application enables an additional user located remotely relative to the mobile telephone to view the predetermined time using the internet.
